(19) United States
(12) Patent Application Publication
(10) Pub. No.: US 2008/0112014 A1
(43) Pub. Date: May 15, 2008

(54) IMAGE FORMING APPARATUS AND IMAGE PROCESSING METHOD

(75) Inventor: Hirochika Sato, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/781,397

(22) Filed: Jul. 23, 2007

(30) Foreign Application Priority Data
Nov. 15, 2006 (JP) 2006-309316

(51) Int. Cl. H04N 1/00

(52) U.S. Cl. 358/401

(57) ABSTRACT

An image forming apparatus determines whether or not setting for image editing, such as negative/positive inversion or mirror image processing, has been performed for read original image data. Then, in accordance with the determination of whether or not encoded image data exists in the original image data, the image forming apparatus performs image editing, such as negative/positive inversion or mirror image processing, for the entire original image data or for an area of the original image data not corresponding to the encoded image data, and outputs the processed original image to a sheet.

### BACKGROUND OF THE INVENTION

1. Field of the Invention

The present invention relates to image forming apparatuses and image processing methods.

2. Description of the Related Art

As typified by barcodes or the like, techniques for encoding information on products or the like, printing the encoded information on output paper, and reading the information printed on the output paper have been utilized for merchandise management or the like. In this technical field, not only methods for encoding and printing product numbers or the like but also methods for encoding and printing information on images or the like have also been available.

For example, as shown in FIGS. 14 and 15, as an example of the related art, a technique for printing a desired file, such as a document file or an image file, as encoded image data on output paper, reading the encoded image data with a scanner, and decoding the read encoded image data to extract the original file is available.

Referring to FIG. 14, a controller device 11 reads input data 1401, such as a document file or an image file, and encodes (1402) the read input data 1401 to generate encoded image data 1403. A printer device 14 performs combining of the encoded image data 1403, and outputs output paper 1404 on which the encoded image is embedded.

Referring to FIG. 15, the output paper 1404 on which the encoded image is embedded, which is output as shown in FIG. 14, is scanned with a scanner device 13, and the controller device 11 decodes the read data to extract the original input data 1401.

As another example, a technique in which a thumbnail and an original file of the thumbnail are encoded and printed on output paper and an image forming apparatus reads the output paper so that the original file can be printed has been suggested (for example, see Japanese Patent Laid-Open No. 2001-344588).

In addition, as another example of the related art, a technique in which image editing, such as enlarging and reducing, is performed while the reliability in reading of encoded image data is maintained and printing is performed has been suggested (for example, see Japanese Patent Laid-Open No. 2002-354236).

However, the image forming apparatuses of the related art do not take into consideration image editing, such as negative/positive inversion or mirror image processing, for combined image data including encoded image data, and perform negative/positive inversion or mirror image processing for the entire original image. The technique described in Japanese Patent Laid-Open No. 2002-354236 solves the problem relating to the basic image editing, such as enlarging and reducing. However, this technique does not solve the problem relating to more advanced image editing.

Thus, when image editing, such as negative/positive inversion or mirror image processing, is performed, encoded image data may be damaged and the damaged encoded image may be printed on output paper.

That is, when image editing, such as negative/positive inversion or mirror image processing, is performed, encoded image data may be damaged, depending on the processing. In this case, since the damaged encoded image is printed on output paper, the original may not be able to be restored as a user desires.

### SUMMARY OF THE INVENTION

According to an aspect of the present invention, an image processing apparatus performing image editing for original image data includes a determining unit configured to determine whether encoded image data exists in the original image data; and a processing unit configured to, when the determining unit determines that encoded image data does not exist in the original image data, perform the image editing for the original image data, and when the determining unit determines that encoded image data exists in the original image data, perform the image editing for image data in the original image data that is not located in an area corresponding to the encoded image data and combine the image data that has been subjected to the image editing with the encoded image data.

Further features of the present invention will become apparent from the following description of exemplary embodiments with reference to the attached drawings.

### BRIEF DESCRIPTION OF THE DRAWINGS

FIG. 1 shows an exemplary configuration of an image forming system.

FIG. 2 is an external view of input and output devices of an image forming apparatus.

FIG. 3 is a block diagram illustrating in more detail the configuration of a controller device of the image forming apparatus.

FIG. 4 shows tile image data.

FIG. 5 is a block diagram showing a scanner image processing unit.

FIG. 6 is a block diagram showing a printer image processing unit.

FIG. 7 illustrates an example of an operation device.

FIG. 8 illustrates an example of the operation device.

FIG. 9 illustrates an encoded image area.

FIG. 10 is a flowchart of a process to input an original document.

FIG. 11 is a flowchart of a process to add a new encoded image.

FIG. 12 is a flowchart of a process to output image data to output paper.

FIGS. 13A and 13B illustrate mirror image processing.

FIG. 14 illustrates related art in which input data is encoded.

FIG. 15 illustrates related art in which encoded data is decoded and data before being encoded is extracted.

FIG. 16 is a flowchart of a process to input an original document.

FIG. 17 is a flowchart of a process to output image data to output paper.

FIG. 18 is a flowchart of a process to input an original document.

FIG. 19 is a flowchart of a process to output image data to output paper.

### DESCRIPTION OF THE EMBODIMENTS

Embodiments of the present invention will be described with reference to the drawings.

In this specification, the term “image editing” means processing performed for image data. The “image editing” includes processing performed for data, such as binding margin processing, frame erasure processing, binding processing, negative/positive processing, mirror image processing, and encoded image printing processing.

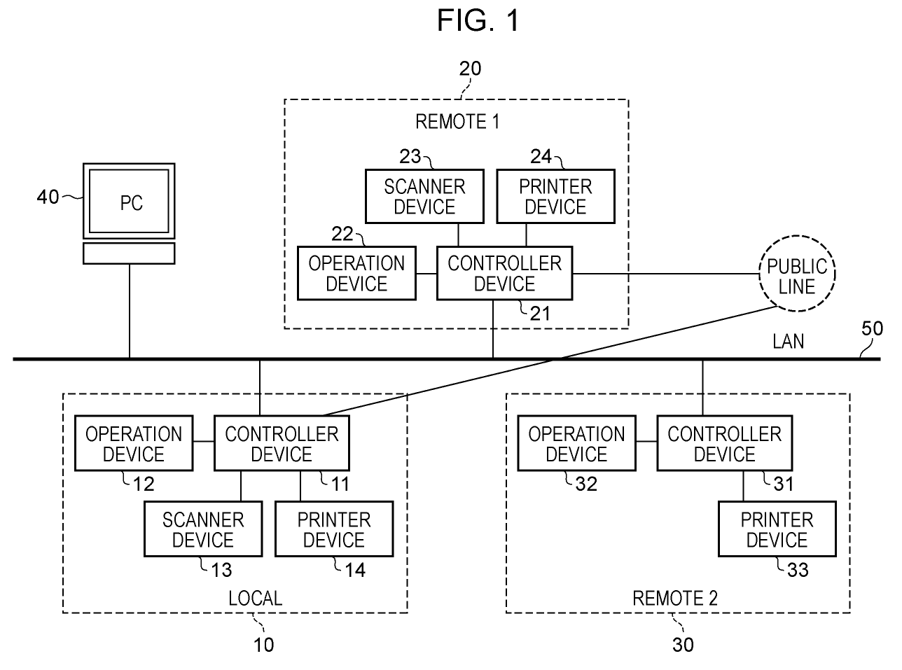

FIG. 1 is a block diagram showing a configuration of a printing system according to an exemplary embodiment of the present invention.

In this printing system, a host computer (PC) 40 and three image forming apparatuses 10, 20, and 30 are connected to a local-area network (LAN) 50. However, in the printing system, the number of connections is not limited to this. In addition, although the PC 40 and the image forming apparatuses 10, 20, and 30 are connected to each other via the LAN 50 in the exemplary embodiment, these apparatuses are not necessarily connected using the LAN 50. For example, these apparatuses may be connected via a desired network, such as a wide-area network ((WAN) public line), serial transmission using a universal serial bus (USB) or the like, parallel transmission using a Centronics interface or a small computer system interface (SCSI), or the like.

The PC 40 has a function of a personal computer. The PC 40 includes a central processing unit (CPU), a read-only memory (ROM) for storing a program, and a random-access memory (RAM). Thus, the PC 40 is capable of transferring files and electronic mail via the LAN 50 or a WAN using a file transfer protocol (FTP) or a server message block (SMB) protocol. With the functions of the CPU and the program, the PC 40 is capable of instructing the image forming apparatuses 10, 20, and 30 to perform printing via a printer driver.

As shown in FIG. 1, the image forming apparatuses 10 and 20 have the same configuration. However, the image forming apparatus 30 has only a print function, that is, the image forming apparatus 30 does not have a scanner device (a scanner device 13 or a scanner device 23), which is provided in the image forming apparatus 10 or 20. For the convenience of description, the configuration of the image forming apparatus 10 will be described as an example.

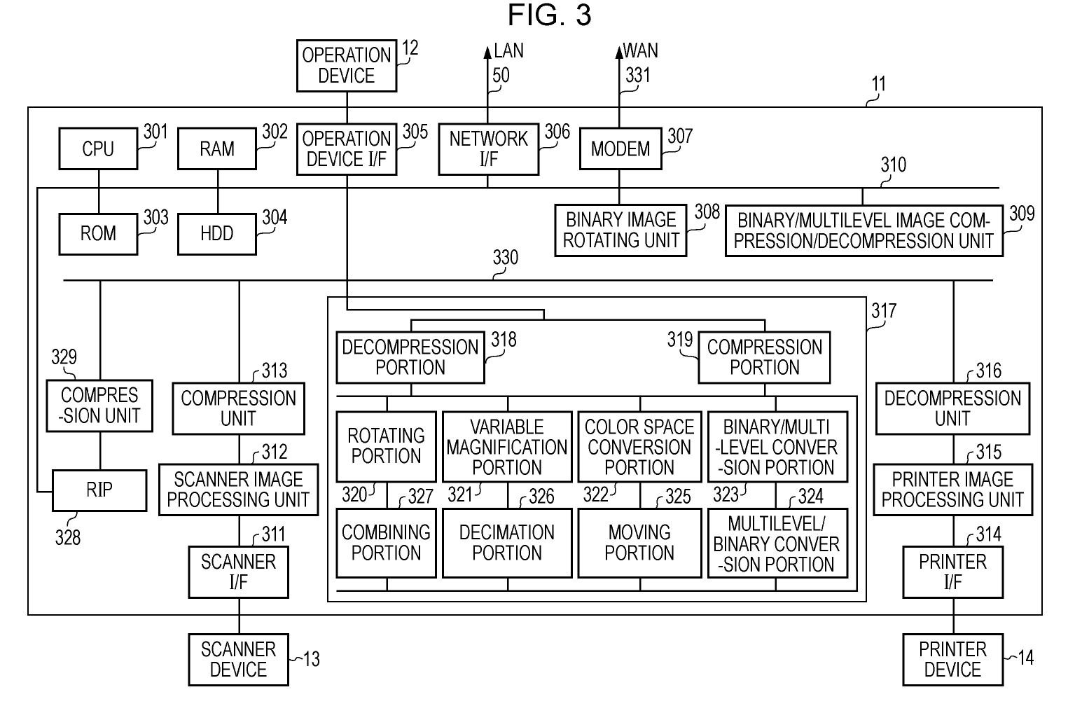

The image forming apparatus 10 includes a controller device 11 that controls the image forming apparatus 10, an operation device 12, which is a user interface used for print settings, the scanner device 13, which is an image input device, and a printer device 14, which is an image output device. The controller device 11 generally controls the operation device 12, the scanner device 13, and the printer device 14. A detailed configuration of the controller device 11 will be described later with reference to FIG. 3.

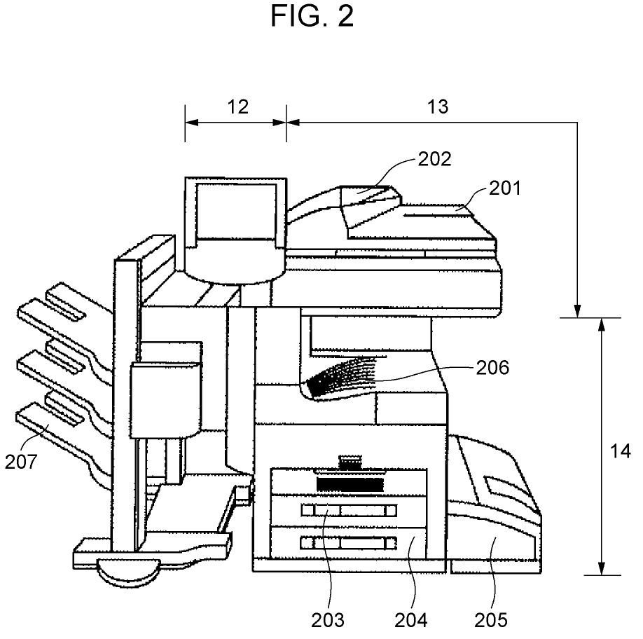

FIG. 2 is an external view of the image forming apparatus 10 according to the first embodiment. The image forming apparatus 10 includes the controller device 11 (not shown in FIG. 2), the operation device 12, the scanner device 13, and the printer device 14, as described above.

The scanner device 13 includes an original document feeder 201 and a tray 202.

The scanner device 13 includes a plurality of charge-coupled devices (CCDs) that share regions to be scanned. The scanner device 13 has a function of converting information on an image into an electric signal by inputting reflected light obtained by exposure scanning of the image of an original document to the plurality of CCDs.

The scanner device 13 converts the converted electric signal into luminance signals formed by R, G, and B colors, and outputs the luminance signals as image data to the controller device 11.

An original document is placed on the tray 202 of the original document feeder 201. When a user issues, using the operation device 12, an instruction to start reading, an original document reading instruction is sent from the controller device 11 to the scanner device 13. After receiving the instruction, the scanner device 13 performs an operation for reading original documents by feeding the original documents page by page from the tray 202 of the original document feeder 201. The reading of original documents is not necessarily based on automatic feeding by the original document feeder 201. An original document placed on a glass table (not shown) may be scanned while an exposure unit is being moved.

The printer device 14 includes a plurality of paper cassettes 203, 204, and 205, a paper output tray 206 from which paper that is not to be subjected to post-processing is output, and a post-processing unit 207. Since the plurality of paper cassettes 203, 204, and 205 are provided, a desired paper size is selected from among different paper sizes and a desired paper orientation is selected from among different paper orientations.

The printer device 14 is an image forming device that forms image data received from the controller device 11 on paper. Although an electrophotography method utilizing a photosensitive drum or a photosensitive belt is adopted in the exemplary embodiment, the image forming method is not limited to this. For example, an inkjet method in which ink ejected from a micro nozzle array is printed on paper may be adopted.

Printed paper on which post-processing has been performed is output to the post-processing unit 207. The post-processing includes, for example, stapling, punching, cutting, and the like for output paper.

FIG. 3 is a block diagram illustrating the configuration of the controller device 11 of the image forming apparatus 10 in more detail. The controller device 11 is electrically connected to the operation device 12, the scanner device 13, and the printer device 14. The controller device 11 is also connected to an external apparatus, such as the PC 40, via the LAN 50 or a WAN 331. With this configuration, image data and device information can be input to or output from the controller device 11.

The controller device 11 includes a CPU 301, a RAM 302, a ROM 303, a hard disk drive (HDD) 304, an operation device I/F 305, a network I/F 306, a modem 307, a binary image rotating unit 308, and a binary/multilevel image compression/decompression unit 309. These units are connected to a system bus 310.

The controller device 11 also includes a scanner I/F 311, a scanner image processing unit 312, a compression unit 313, a printer I/F 314, a printer image processing unit 315, a decompression unit 316, an image conversion unit 317, a raster image processor (RIP) 328, and a compression unit 329. These units are connected to an image bus 330. The image conversion unit 317 includes a decompression portion 318, a compression portion 319, a rotating portion 320, a variable magnification portion 321, a color space conversion portion 322, a binary/multilevel conversion portion 323, a multilevel/binary conversion portion 324, a moving portion 325, a decimation portion 326, and a combining portion 327.

The system bus 310 and the image bus 330 are connected to each other. Thus, the above-mentioned units are connected to each other via the system bus 310 and the image bus 330 and are capable of transferring data between each other. The RIP 328 is also connected to the system bus 310.

Each of the units of the controller device 11 will now be described.

The CPU 301 generally controls access to various connected devices (for example, the scanner device 13 and the like) on the basis of a control program stored in the ROM 303 and generally controls various types of processing performed inside the controller device 11.

The RAM 302 is a system work memory for the operation of the CPU 301 and serves as a memory for temporarily storing image data. The RAM 302 includes an SRAM that maintains stored contents even after the power is turned off and a DRAM that erases stored contents after the power is turned off.

The ROM 303 stores the above-mentioned apparatus control program, a boot program, and the like.

The HDD 304 stores system software and image data.

The operation device I/F 305 is an interface unit for connecting the system bus 310 to the operation device 12. The operation device I/F 305 receives information to be indicated on the operation device 12 from various units via the system bus 310 and transmits the received information to the operation device 12. The operation device I/F 305 also transmits the received information to various units via the system bus 310.

The network I/F 306 is connected to the LAN 50 and the system bus 310 and performs transfer of information to and from the LAN 50 and the system bus 310.

The modem 307 is connected to the WAN 331 and the system bus 310 and performs transfer of information to and from the WAN 331 and the system bus 310.

The network I/F 306 and the modem 307 are connected to an external computer, such as the PC 40, via the LAN 50 and the WAN 331, respectively. Thus, the network I/F 306 and the modem 307 are capable of receiving print settings from the PC 40 or the like.

The binary image rotating unit 308 changes the orientation of image data before being transmitted.

The binary/multilevel image compression/decompression unit 309 converts the resolution of image data before being transmitted into a predetermined resolution or a resolution corresponding to the capability of a receiver. A method, such as Joint bi-level image experts group (JBIG), modified modified read (MMR), modified read (MR), or modified Huffman (MH), is used for compression and decompression.

The image bus 330 is a transmission channel used for transfer of image data. The image bus 330 includes a peripheral component interconnect (PCI) bus or IEEE 1394.

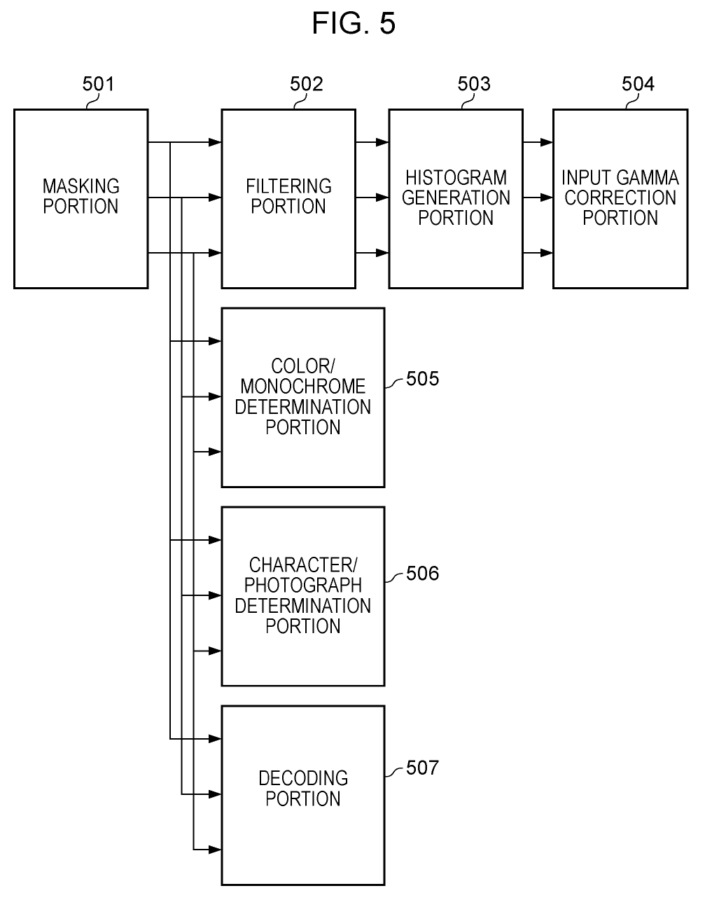

The scanner image processing unit 312 performs correction, processing, and editing of image data received via the scanner I/F 311 from the scanner device 13. The scanner image processing unit 312 is capable of determining whether the received image data is a color document or a monochrome document and whether the received image data is a character document or a photograph document. In addition, the scanner image processing unit 312 adds the determination results to the image data. Here, the additional information is referred to as “attribute data.” The processing performed by the scanner image processing unit 312 will be described later with reference to FIG. 5.

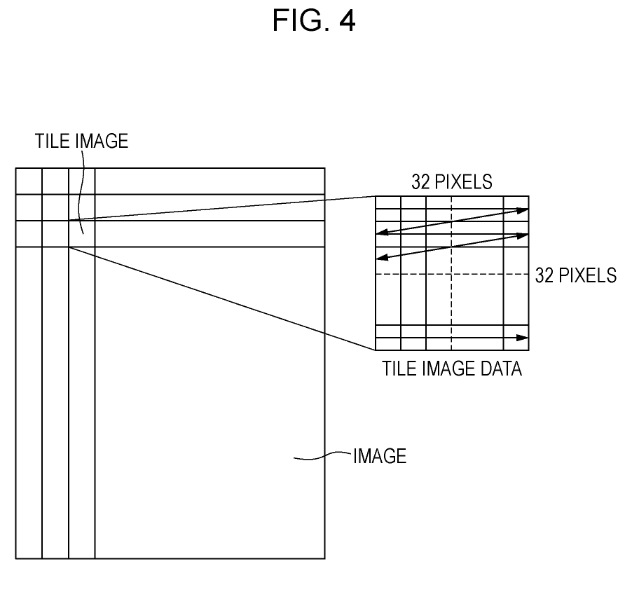

The compression unit 313 receives image data from the scanner image processing unit 312 and divides the image data into a plurality of blocks each including 32×32 pixels. The image data including 32×32 pixels is called tile image data. FIG. 4 shows the tile image data. In an original document (that is, a paper medium before being read by the scanner device 13), a region corresponding to the tile image data is called a tile image.

Average luminance information of a block including 32×32 pixels and a coordinate position of the tile image on the original document are added as header information to the tile image data. The compression unit 313 also compresses image data including a plurality of pieces of tile image data.

The decompression unit 316 decompresses the image data including the plurality of pieces of image data, performs raster expansion of the decompressed image data, and transmits the image data that has been subjected to raster expansion to the printer image processing unit 315.

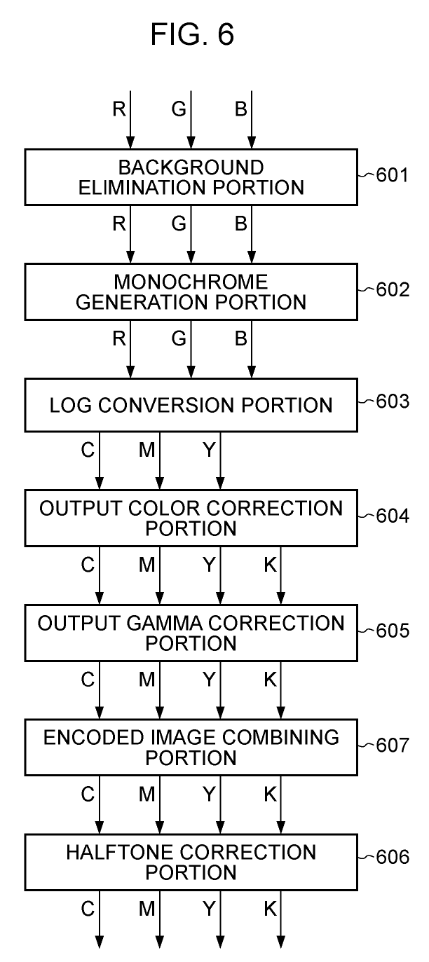

The printer image processing unit 315 receives image data from the decompression unit 316, refers to attribute data added to the image data, and performs image processing for the image data. Image data that has been subjected to image processing is output via the printer I/F 314 to the printer device 14. The processing performed by the printer image processing unit 315 will be described later with reference to FIG. 6.

The image conversion unit 317 performs predetermined conversion processing for image data. The image conversion unit 317 includes the various processing portions, as described above.

The decompression portion 318 decompresses received image data. The compression portion 319 compresses received image data. The rotating portion 320 rotates received image data.

The variable magnification portion 321 performs resolution conversion of received image data (for example, conversion from a resolution of 600 dpi to a resolution of 200 dpi).

The color space conversion portion 322 converts the color space of received image data. The color space conversion portion 322 is capable of performing background elimination, LOG conversion (RGB→CMY), and output color correction (CMY→CMYK), which are well-known techniques, using a matrix or a table.

The binary/multilevel conversion portion 323 converts received 2-grayscale image data into 256-grayscale image data.

The multilevel/binary conversion portion 324 converts received 256-grayscale image data into 2-grayscale image data by a procedure, such as error diffusion processing.

The moving portion 325 adds a margin to received image data or deletes a margin from the received image data.

The decimation portion 326 performs resolution conversion by eliminating some pixels of received image data. For example, the decimation portion 326 generates image data having a resolution that is half, one-fourth, or one-eighth the resolution of the original image data.

The combining portion 327 combines two received pieces of image data to generate a piece of image data. For combining of two pieces of image data, a well-known method can be used. That is, a method for using the average of luminance values of pixels to be combined as a combined luminance value, a method for using a luminance value of a pixel whose luminance level is higher as a luminance value of a combined pixel, or a method for using a luminance value of a pixel whose luminance level is lower as a luminance value of a combined pixel can be adopted. In addition, a method for determining a luminance value after combination in accordance with logical OR, logical AND, or exclusive OR of pixels to be combined can be adopted.

The RIP 328 receives intermediate data generated based on page description language (PDL) code data transmitted from the PC 40 or the like, and generates bitmap data (multilevel data).

FIG. 5 shows a detailed internal configuration of the scanner image processing unit 312 shown in FIG. 3.

The scanner image processing unit 312 includes a masking portion 501, a filtering portion 502, a histogram generation portion 503, an input gamma correction portion 504, a color/monochrome determination portion 505, a character/photograph determination portion 506, and a decoding portion 507.

The scanner image processing unit 312 has a function of receiving image data formed by 8-bit R, G, and B luminance signals.

The masking portion 501 converts the luminance signals into standard luminance signals not depending on filter colors of CCDs.

The filtering portion 502 corrects the spatial frequency of image data received from the masking portion 501 in a desired manner. The filtering portion 502 performs arithmetic processing for the image data using, for example, a 7×7 matrix.

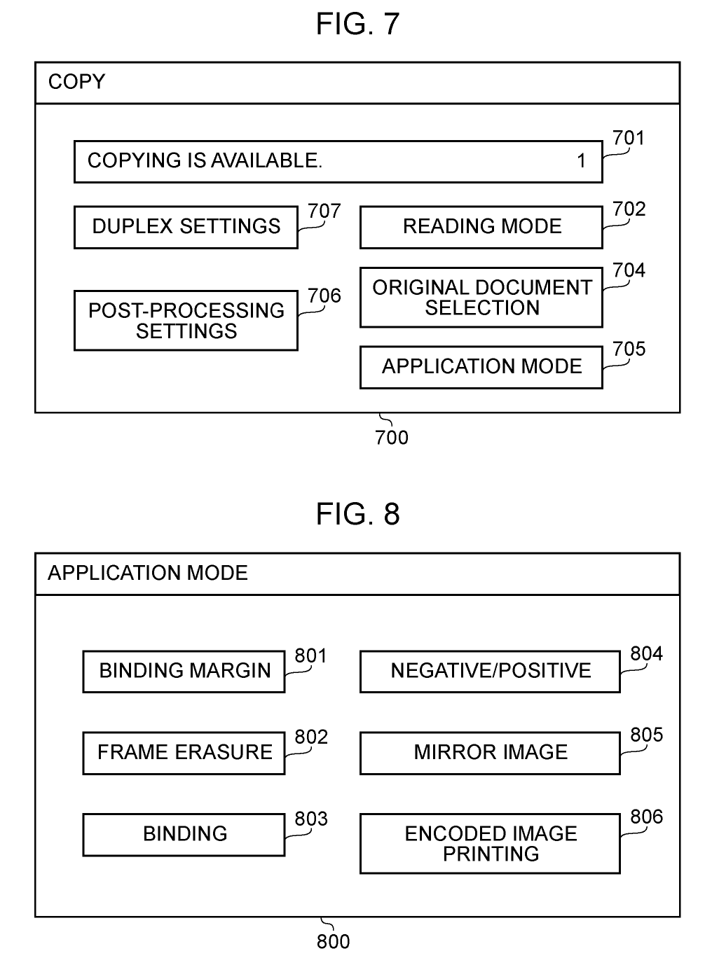

In a copying machine or a complex machine, when an original document selection button 704 shown in FIG. 7 is pressed, one of a character mode, a photograph mode, a character/photograph mode can be selected as a copy mode. When the character mode is selected, the filtering portion 502 provides the entire image data with character filtering. When the photograph mode is selected, the filtering portion 502 provides the entire image data with photograph filtering. When the character/photograph mode is selected, the filtering portion 502 selectively provides each pixel with suitable filtering in accordance with a character/photograph determination signal (part of attribute data), which will be described later. That is, the filtering portion 502 determines whether photograph filtering or character filtering is to be provided to each pixel.

A coefficient for smoothing of only a high-frequency component is set for photograph filtering. Thus, with the photograph filtering, roughness of images can be made less conspicuous. A coefficient for strong edge enhancement is set for character filtering. Thus, with the character filtering, sharpness of characters can be increased.

The histogram generation portion 503 samples luminance data of each of a plurality of pixels forming image data received from the filtering portion 502. More specifically, the histogram generation portion 503 samples, at predetermined pitches in a main-scanning direction and a sub-scanning direction, luminance data within a rectangular area defined in the main-scanning direction and the sub-scanning direction from a start point to an end point. The histogram generation portion 503 generates histogram data on the basis of the sampling results. The generated histogram data is used for estimating a background level when a background elimination portion 601, which will be described later, performs background elimination.

The input gamma correction portion 504 converts, using a table or the like, luminance data received from the histogram generation portion 503 into luminance data having nonlinear characteristics.

The color/monochrome determination portion 505 determines whether each of a plurality of pixels forming image data received from the masking portion 501 has a chromatic color or an achromatic color. The color/monochrome determination portion 505 adds the determined results as color/monochrome determination signals (part of attribute data) to the image data.

The character/photograph determination portion 506 determines whether each of the plurality of pixels forming the image data received from the masking portion 501 is a pixel forming a character region, a pixel forming a halftone-dot region, a pixel forming a character in a halftone-dot region, or a pixel forming a solid image region. The character/photograph determination portion 506 performs the determination in accordance with a pixel value of each pixel and pixel values of pixels adjacent to the pixel. When a pixel does not correspond to any of the above-mentioned cases, the character/photograph determination portion 506 determines that the pixel is a pixel forming a white region. After the determination, the character/photograph determination portion 506 adds the determination results as character/photograph determination signals (part of attribute data) to the image data.

When encoded image data exists in the image data output from the masking portion 501, the decoding portion 507 detects the encoded image data. When detecting encoded image data, the decoding portion 507 decodes the detected encoded image data to extract information.

The flow of the processing performed by the printer image processing unit 315 shown in FIG. 3 will be described with reference to FIG. 6. As described above, the processing of the printer image processing unit 315 is controlled by the CPU 301. Thus, the processing described below is performed under the control of the CPU 301.

The background elimination portion 601 performs processing for eliminating a background color of image data using a histogram generated by the histogram generation portion 503 of the scanner image processing unit 312.

A monochrome generation portion 602 converts color data into monochrome data.

A Log conversion portion 603 performs conversion of luminance and density. For example, the Log conversion portion 603 converts RGB input image data into CMY image data.

An output color correction portion 604 performs output color correction. For example, the output color correction portion 604 converts, using a table or a matrix, CMY input image data into CMYK image data.

An output gamma correction portion 605 performs correction such that a signal value input to the output gamma correction portion 605 is proportional to a reflection density after copying and outputting is performed.

A halftone correction portion 606 performs halftone processing in accordance with the number of grayscale levels of the printer device 14. For example, the halftone correction portion 606 converts received image data having a high grayscale level into binary image data or 32-grayscale image data.

An encoded image combining portion 607 is disposed between the output gamma correction portion 605 and the halftone correction portion 606. The encoded image combining portion 607 combines encoded image data generated by encoding processing, which will be described later, with original image data.

Each of the processing portions of the scanner image processing unit 312 and the printer image processing unit 315 is capable of outputting received image data without performing any processing. This operation, that is, passing through a processing portion without being subjected to any processing is called “passing through a processing portion.”

The CPU 301 is capable of performing encoding processing of predetermined information (including, for example, an apparatus number, print time information, user ID information, and the like) and controlling processing for generating encoded image data.

In this specification, encoded image data may be a two-dimensional code image, a barcode image, an electronic watermark image generated by an electronic watermark technique, or the like. As shown in FIG. 14, encoded image data can be generated from a document file, an image file, a moving image file, a sound file, an execution file, or the like.

The CPU 301 is also capable of transmitting, using a data bus (not shown), generated encoded image data to the encoded image combining portion 607 of the printer image processing unit 315.

The above-mentioned control (generation control and transmission control of an encoded image) is performed when the CPU 301 executes a program stored in the RAM 302.

The operation device 12 of the image forming apparatus 10 will be described in more detail next.

FIG. 7 shows an initial screen 700 of the operation device 12. The initial screen 700 includes a status field 701, a reading mode button 702, an original document selection button 704, an application mode button 705, a post-processing setting button 706, and a duplex setting button 707.

The status field 701 indicates whether or not the image forming apparatus 10 is capable of performing copying. The status field 701 also indicates the set number of copies.

The reading mode button 702 is used for selecting a mode for reading an original document. When the reading mode button 702 is pressed, a popup menu for selecting one of three reading modes, that is, color, black, and automatic (ACS) modes, is displayed. When the color mode is selected, color copying is performed. When the black mode is selected, monochrome copying is performed. When the automatic (ACS) mode is selected, the color mode or the monochrome mode is determined in accordance with a color/monochrome determination signal generated by the color/monochrome determination portion 505.

The original document selection button 704 is used for selecting the type of original document. When the original document selection button 704 is pressed, a popup menu (not shown) for selecting one of three modes, that is, character, photograph, and character/photograph modes, is displayed.

The application mode button 705 is used for setting image editing to be performed for original image data obtained by reading an original document.

The post-processing setting button 706 is used for performing settings for finishing of original image data obtained by reading an original document.

The duplex setting button 707 is used for performing settings for duplex reading and duplex printing.

FIG. 8 shows an example of an application mode setting screen 800 presented when the application mode button 705 is pressed. In exemplary embodiments, the application mode setting screen 800 includes a binding margin setting button 801, a frame erasure setting button 802, a binding setting button 803, a negative/positive setting button 804, a mirror image setting button 805, and an encoded image printing button 806.

The binding margin setting button 801 is used for setting a binding margin. The binding margin is set so that an original image is printed on output paper so as to be shifted vertically or horizontally.

The frame erasure setting button 802 is used for setting frame erasure in which the frame of an original image is defined and pixels outside the frame are converted into white pixels.

The binding setting button 803 is used for performing binding setting for binding an original image into a book and outputting the bound original image.

The negative/positive setting button 804 is used for performing negative/positive setting of an original image. When the negative/positive setting button 804 is pressed, a negative/positive ON/OFF screen (not shown) is presented. A user is able to select whether or not negative/positive outputting is performed. As initial setting, a value not allowing negative/positive outputting is set.

The mirror image setting button 805 is used for performing mirror image setting in which an original image is subjected to mirror image printing by rotating the original image vertically or horizontally. When the mirror image setting button 805 is pressed, a mirror image ON/OFF screen (not shown) is presented. The user is able to select whether or not mirror image outputting is performed. As initial setting, a value not allowing mirror image outputting is set.

The encoded image printing button 806 is used for setting a mode in which new encoded image data is combined with an original image. Information to be converted into encoded image data is not particularly limited. For example, information to be converted into encoded image data may be a document file stored in the PC 40 or the HDD 304 of the image forming apparatus 10 or a character string input using a virtual keyboard (not shown).

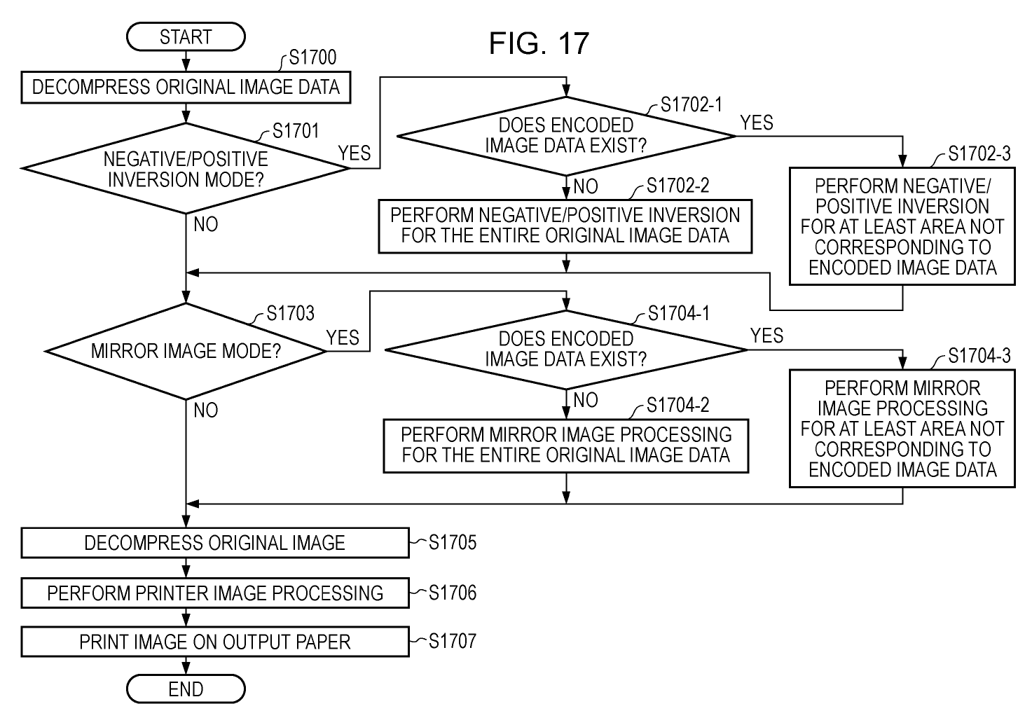

FIGS. 16 and 17 are flowcharts showing a series of processing for reading an original document, storing the original document as original image data, performing image editing (for example, negative/positive inversion or mirror image processing) for the stored original image data, and forming an image of the processed original image data on a sheet. In the flowcharts shown in FIGS. 16 and 17, the RAM 302 is simply referred to as a memory.

Before the processes shown in FIGS. 16 and 17 start, the user places an original document on the scanner device 13 and presses the application mode button 705 (the negative/positive setting button 804 or the mirror image setting button 805) to request the image forming apparatus 10 to perform settings for image editing (for example, negative/positive processing or mirror image processing). After making the request, the user presses a start button to instruct the image forming apparatus 10 to perform the image editing for original image data obtained by scanning of the original document placed on the original document feeder 201 and form an image of the processed original image data on a sheet.

In step S1600, the CPU 301 performs settings for image editing (for example, negative/positive processing or mirror image processing).

In step S1601, the CPU 301 transmits the original document read by the scanner device 13 as original image data to the scanner image processing unit 312 via the scanner I/F 311.

In step S1602, the scanner image processing unit 312 performs the processing described with reference to FIG. 5 for the original image data transmitted in step S1601 to generate new original image data.

In step S1603, the decoding portion 507 of the scanner image processing unit 312 determines whether or not encoded image data exists in the new original image data generated in step S1602. When the decoding portion 507 detects encoded image data in step S1603, the CPU 301 proceeds to step S1604. When the decoding portion 507 does not detect encoded image data in step S1603, the CPU 301 proceeds to step S1608.

In step S1604, the decoding portion 507 determines an area of the original image corresponding to the detected encoded image data and transmits information on the area to the encoded image combining portion 607.

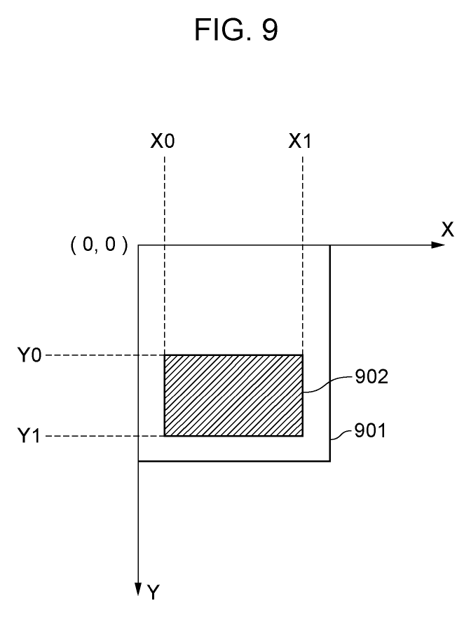

In this specification, area information indicates the position coordinates of an area occupied by encoded image data 902 when the origin (0,0) is set at the upper left corner of an original image 901, the main-scanning direction is defined as X axis, and the sub-scanning direction is defined as Y axis, as shown in FIG. 9. In the example shown in FIG. 9, the area corresponding to the encoded image data 902 is defined by a rectangular area enclosed by position coordinates (X0,Y0), (X1,Y0), (X0,Y1), and (X1,Y1).

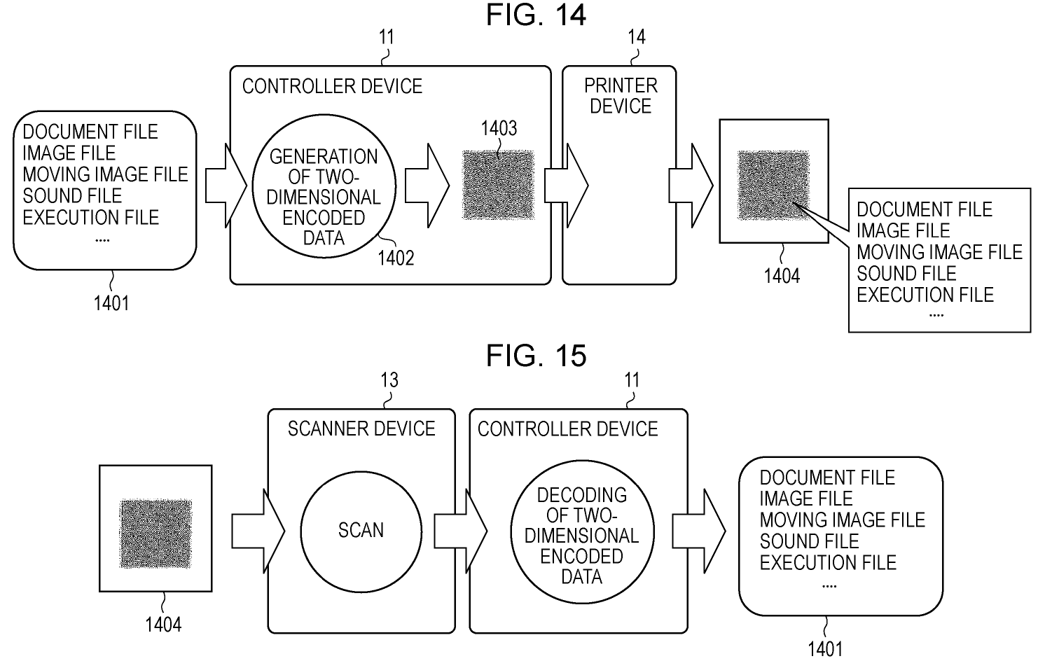

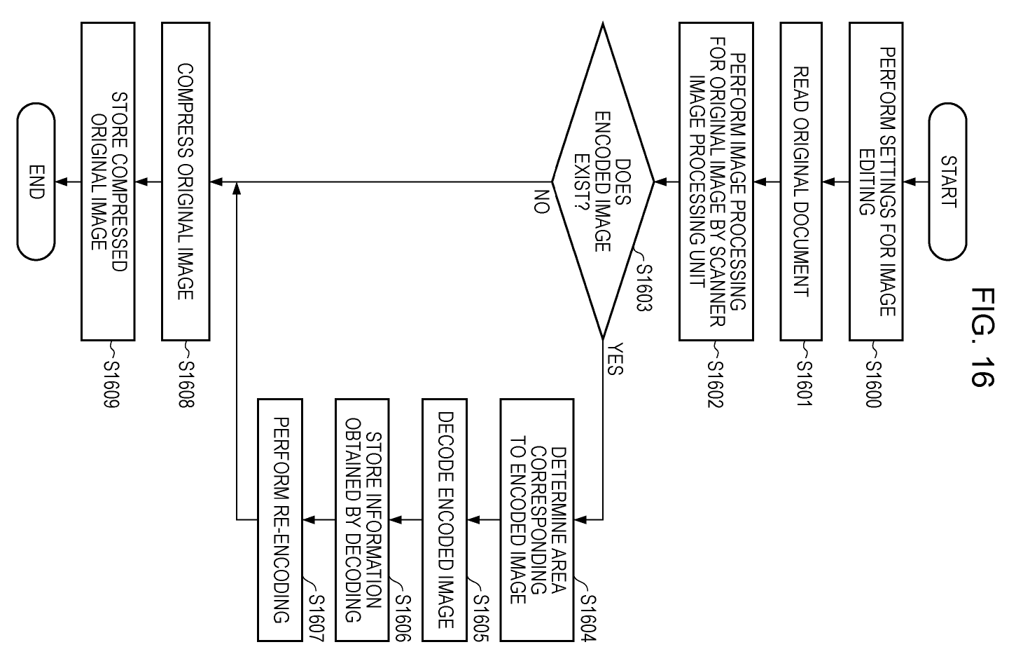

In step S1605, the decoding portion 507 decodes the encoded image data to acquire information. Since image editing, such as negative/positive inversion or mirror image processing, has not been performed at this stage, the encoded image data has not been damaged. Thus, the original data can be extracted from the encoded image data, as shown in FIG. 15.

In step S1606, the CPU 301 transmits, using a data bus (not shown), the information obtained by decoding in step S1605 to the RAM 302, and the information is stored in the RAM 302.

In step S1607, the CPU 301 re-encodes the decoded information to generate re-encoded image data, and transmits the re-encoded image data to the encoded image combining portion 607 of the printer image processing unit 315. Combining processing performed by the encoded image combining portion 607 will be described later as the processing of step S1706.

In step S1608, the compression unit 313 divides the new original image data generated by the scanner image processing unit 312 into a plurality of blocks each including 32×32 pixels to generate a plurality of pieces of tile image data. The compression unit 313 also compresses the original image data including the plurality of pieces of tile image data.

In step S1609, the CPU 301 transmits the original image data compressed by the compression unit 313 to the memory, and the compressed original image data is stored in the memory. Then, the CPU 301 proceeds to the process shown in FIG. 17.

In step S1700, the CPU 301 decompresses the compressed original image data and stores the decompressed original image data in the memory.

In step S1701, the CPU 301 determines whether or not negative/positive inversion is set as image editing (the setting is performed in step S1600). When the CPU 301 determines in step S1701 that negative/positive inversion has been designated, the CPU 301 proceeds to step S1702-1. When the CPU 301 determines in step S1701 that negative/positive inversion has not been designated, the CPU 301 proceeds to step S1703.

In step S1702-1, the CPU 301 determines whether or not encoded image data exists in the original image data in accordance with the result of the determination performed in step S1603. When the CPU 301 determines in step S1702-1 that encoded image data exists in the original image data, the CPU 301 performs negative/positive inversion to invert the luminance of an image for the entire decompressed original image data stored in the memory (step S1702-2) (or for image data in the decompressed original image data that is not located in an area corresponding to the encoded image data (step S1702-3)). When the CPU 301 determines in step S1702-1 that encoded image data does not exist in the original image data, the CPU 301 performs negative/positive inversion for the entire decompressed original image data stored in the memory (step S1702-2).

Then, the processed image data is stored in the memory. When negative/positive inversion is performed only for the image data in the decompressed original image data that is not located in an area corresponding to the encoded image data, combined image data of the image data that has been subjected to negative/positive inversion and the encoded image data is stored as the processed image data in the memory. In the negative/positive inversion, RGB data of each pixel is inverted. For example, when a pixel value is between 0 and 255, values obtained by subtracting RGB values of a pixel from 255, which is the maximum pixel value, are used as respective RGB values of the pixel after inversion.

In step S1703, the CPU 301 determines whether or not mirror image outputting is set as image editing (the setting is performed in step S1600). When the CPU 301 determines in step S1703 that mirror image outputting has been designated, the CPU 301 proceeds to step S1704-1. When the CPU 301 determines in step S1703 that mirror image outputting has not been designated, the CPU 301 proceeds to step S1705.

In step S1704-1, the CPU 301 determines whether or not encoded image data exists in the original image data in accordance with the result of the determination performed in step S1603. When the CPU 301 determines in step S1704-1 that encoded image data exists in the original image data, the CPU 301 performs mirror image processing for the entire decompressed original image data stored in the memory (step S1704-2) (or for image data in the decompressed original image data that is not located in an area corresponding to the encoded image data (step S1704-3)). When the CPU 301 determines in step S1704-1 that encoded image data does not exist in the original image data, the CPU 301 performs mirror image processing for the entire decompressed original image data stored in the memory (step S1704-2).

When mirror image processing is performed only for the image data in the decompressed original image data that is not located in an area corresponding to the encoded image data, combined image data of the image data that has been subjected to mirror image processing and the encoded image data is stored as the processed image data in the memory.

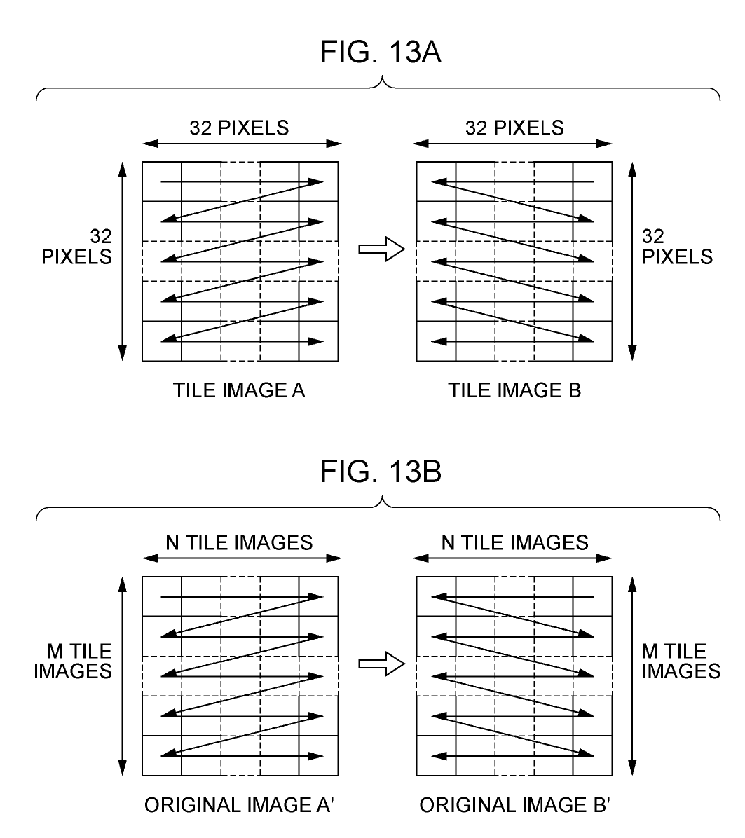

The mirror image processing will now be described with reference to FIGS. 13A and 13B. Referring to FIGS. 13A and 13B, mirror image processing is performed for each of a plurality of pieces of tile image data (that is, each of a plurality of pieces of image data each including 32×32 pixels), as shown in FIG. 4. In the mirror image processing, an image is vertically inverted or horizontally inverted as if the image is reflected in a mirror. Then, the arrangement of the plurality of pieces of tile image data is changed.

The mirror image processing will be explained with reference to FIGS. 13A and 13B. Tile image data A includes 32×32 pixels. Mirror image processing is performed for each of the plurality of pixels. A pixel located on the upper left corner of the tile image data A is moved to a position corresponding to the upper right corner of tile image data B. That is, not only mirror image processing is performed for each of a plurality of pixels of image data, but also the position of tile image data is changed as if a tile image is reflected in a mirror. By performing such processing for each pixel, the tile image data B is obtained.

Although an example of left-right symmetry mirror image processing has been explained, top-bottom symmetry mirror image processing can be performed.

In addition, as shown in FIG. 13B, an original image A′ includes M×N pieces of tile image data. For the original image A′, processing for displacing each tile image so as to achieve left-right symmetry is performed. By performing such processing, an original image B′ is obtained.

Here, although an example of left-right symmetry mirror image processing has been explained, top-bottom symmetry mirror image processing can be performed.

In step S1705, the CPU 301 transmits the image data stored in the memory to the decompression unit 316, causes the decompression unit 316 to perform raster expansion, and transmits image data that has been subjected to raster expansion to the printer image processing unit 315.

In step S1706, the printer image processing unit 315 performs image data editing corresponding to attribute data added to the original image data transmitted from the decompression unit 316. The processing contents are equal to the processing contents described with reference to FIG. 6. Then, in this processing, the re-encoded image data generated in step S1607 is combined with the original image data. That is, the encoded image combining portion 607 of the printer image processing unit 315 combines the transmitted re-encoded image data with the original image data in accordance with the position coordinates.

More specifically, when mirror image processing is not performed (the image data editing does not include mirror image processing), the re-encoded image data is combined with the original image data that has been subjected to the image data editing in the original position. The original position is the position of the encoded image data in the original image data before been subjected to the image data editing.

In contrast, when mirror image processing is performed (the image data editing includes mirror image processing), the re-encoded image data is moved from the original position to a position corresponding to mirror image processing, and the re-encoded image data whose position has been moved is combined with the original image data that has been subjected to the image data editing. The original position is the position of the encoded image data in the original image data before being subjected to the image data editing. The position corresponding to mirror image processing, which is moved from the original position, is the position that is vertically or horizontally symmetrical to the original position.

As described above, in this embodiment, combining of the re-encoded image data can be performed in a position corresponding to mirror image processing by moving the re-encoded image data from the original position. This is because the re-encoded image data has a symmetric shape. Since the re-encoded image data has a symmetric shape, even when an area surrounding the re-encoded image data is subjected to mirror image processing, combining of the re-encoded image data with the surrounding area can be achieved only by moving the position of the re-encoded image data without changing the shape of the re-encoded image data.

If the re-encoded image data does not have a symmetric shape (if the re-encoded image data is not rectangular), it is difficult to combine the re-encoded image data in a position corresponding to mirror image processing by moving the re-encoded image data from the original position, unlike this embodiment. For example, in a case where the re-encoded image data has a “P” shape, if an area surrounding the re-encoded image data is subjected to mirror image processing (for example, moved to a position symmetrical to the original position with respect to the horizontal axis), an area in which the re-encoded image data is to be combined has a “d” shape. However, since the re-encoded image data has the “P” shape, the re-encoded image data cannot be disposed in the area.

The encoded image combining portion 607 combines the original image data outputted from the output gamma correction portion 605 with the re-encoded image data generated in step S1607.

Then, the halftone correction portion 606 performs halftone processing for the combined image data in accordance with the number of grayscale levels of the printer device 14. The combined image data that has been subjected to halftone processing is transmitted via the printer I/F 314 to the printer device 14.

In step S1707, the printer device 14 forms an image of the combined image data on output paper.

In the exemplary embodiment described above, information is read from encoded image data included in original image data and re-encoded image data is generated. In addition, image editing is performed for image data in the original image data that is not located in an area corresponding to the encoded image data. Then, the re-encoded image data is combined with the image data that has been subjected to image editing.

In another exemplary embodiment, encoded image data included in original image data is stored in a memory. Image editing is performed for image data in the original image data that is not located in an area corresponding to the encoded image data. Then, the encoded image data stored in the memory is combined with the image data that has been subjected to image editing.

Unlike the previously-described embodiment, reading of information from encoded image data or generation of re-encoded image data using the information is not performed in the present exemplary embodiment. Thus, processing can be performed at a higher speed. In this embodiment, since encoded image data included in the original image data is directly formed on a sheet, the image quality of the encoded image data may be further deteriorated when the encoded image data is formed on the sheet. Thus, information may not be able to be read from the encoded image formed on the sheet by an encoded image reader (for example, a barcode reader or a decoder).

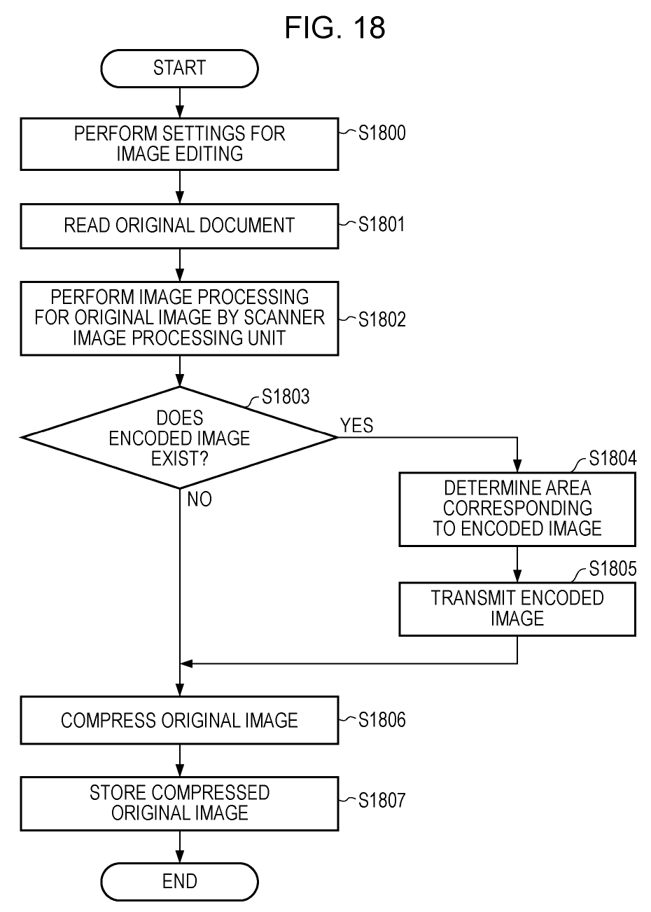

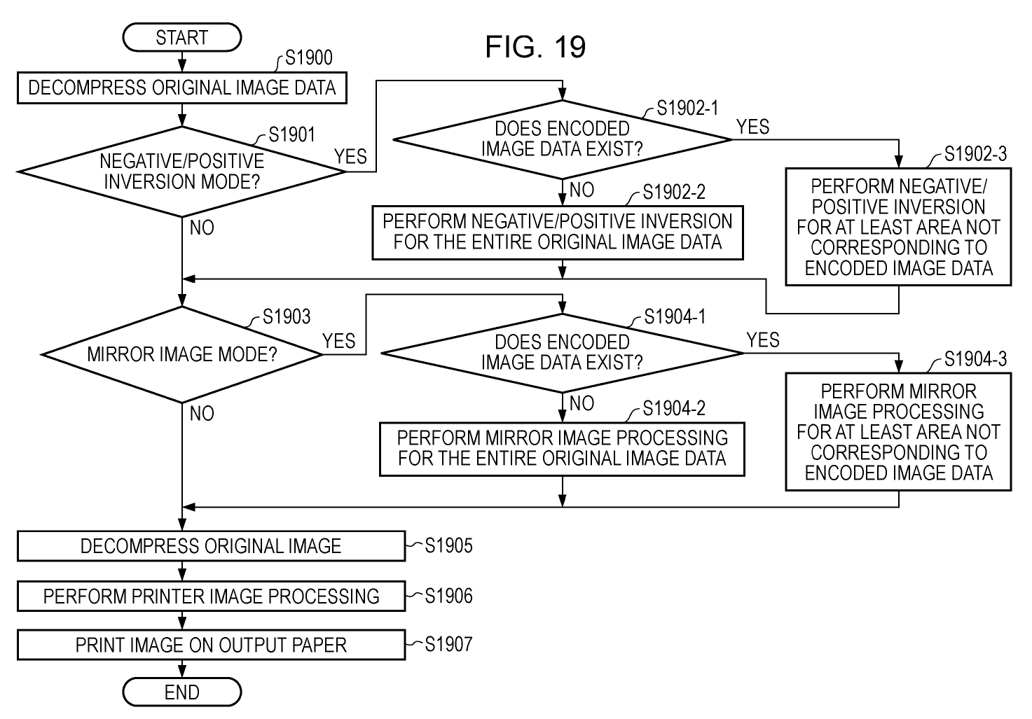

FIGS. 18 and 19 are flowcharts showing a series of processing for reading an original document, storing the original document as original image data, performing image editing (for example, negative/positive inversion or mirror image processing) for the stored original image data, and forming an image of the processed original image data on a sheet. In the flowcharts shown in FIGS. 18 and 19, the RAM 302 is simply referred to as a memory.

Before the processes shown in FIGS. 18 and 19 start, the user places an original document on the scanner device 13 and presses the application mode button 705 (the negative/positive setting button 804 or the mirror image setting button 805) to request the image forming apparatus 10 to perform settings for image editing (for example, negative/positive processing or mirror image processing). After making the request, the user presses a start button to instruct the image forming apparatus 10 to perform the image editing for original image data obtained by scanning of the original document placed on the original document feeder 201 and form an image of the processed original image data on a sheet.

In step S1800, the CPU 301 performs settings for image editing (for example, negative/positive processing or mirror image processing).

In step S1801, the CPU 301 transmits the original document read by the scanner device 13 as original image data to the scanner image processing unit 312 via the scanner I/F 311.

In step S1802, the scanner image processing unit 312 performs the processing described with reference to FIG. 5 for the original image data transmitted in step S1801 to generate new original image data.

In step S1803, the decoding portion 507 of the scanner image processing unit 312 determines whether or not encoded image data exists in the new original image data generated in step S1802. If it is determined that encoded image data exists, processing proceeds to step S1804. If it is determined that encoded image data does not exist, processing proceeds to step S1806.

In step S1804, the decoding portion 507 determines an area of the original image corresponding to the detected encoded image data, and transmits information on the area and the detected encoded image data to the encoded image combining portion 607.

In step S1805, the CPU 301 transmits the encoded image data stored in the RAM 302 to the encoded image combining portion 607 of the printer image processing unit 315. Combining processing performed by the encoded image combining portion 607 will be described later as the processing of step S1906.

In step S1806, the compression unit 313 divides the new original image data generated by the scanner image processing unit 312 into a plurality of blocks each including 32×32 pixels to generate a plurality of pieces of tile image data. The compression unit 313 also compresses the original image data including the plurality of pieces of tile image data.

In step S1807, the CPU 301 transmits the original image data compressed by the compression unit 313 to the memory, and the compressed original image data is stored in the memory. Then, the CPU 301 proceeds to the process shown in FIG. 19.

In step S1900, the CPU 301 decompresses the compressed original image data and stores the decompressed original image data in the memory.

In step S1901, the CPU 301 determines whether or not negative/positive inversion is set as image editing (the setting is performed in step S1800). When the CPU 301 determines in step S1901 that negative/positive inversion has been designated, the CPU 301 proceeds to step S1902-1. When the CPU 301 determines in step S1901 that negative/positive inversion has not been designated, the CPU 301 proceeds to step S1903.

In step S1902-1, the CPU 301 determines whether or not encoded image data exists in the original image data in accordance with the result of the determination performed in step S1803. When the CPU 301 determines in step S1902-1 that encoded image data exists in the original image data, the CPU 301 performs negative/positive inversion to invert the luminance of an image, for the entire decompressed original image data stored in the memory (step S1902-2) (or for image data in the decompressed original image data that is not located in an area corresponding to the encoded image data (step S1902-3)). When the CPU 301 determines in step S1902-1 that encoded image data does not exist in the original image data, the CPU 301 performs negative/positive inversion for the entire decompressed original image data stored in the memory (step S1902-2). Then, the processed image data is stored in the memory. When negative/positive inversion is performed only for the image data in the decompressed original image data that is not located in an area corresponding to the encoded image data, combined image data of the image data that has been subjected to negative/positive inversion and the encoded image data is stored as the processed image data in the memory. In the negative/positive inversion, RGB data of each pixel is inverted. For example, when a pixel value is between 0 and 255, values obtained by subtracting RGB values of a pixel from 255, which is the maximum pixel value, are used as respective RGB values of the pixel after inversion.

In step S1903, the CPU 301 determines whether or not mirror image processing is set as image editing (the setting is performed in step S1800). When the CPU 301 determines in step S1903 that mirror image processing has been designated, the CPU 301 proceeds to step S1904-1. When the CPU 301 determines in step S1903 that mirror image processing has not been designated, the CPU 301 proceeds to step S1905.

In step S1904-1, the CPU 301 determines whether or not encoded image data exists in the original image data in accordance with the result of the determination performed in step S1803. When the CPU 301 determines in step S1904-1 that encoded image data exists in the original image data, the CPU 301 performs mirror image processing for the entire decompressed original image data stored in the memory (step S1904-2) (or for image data in the decompressed original image data that is not located in an area corresponding to the encoded image data (step S1904-3)). When the CPU 301 determines in step S1904-1 that encoded image data does not exist in the original image data, the CPU 301 performs mirror image processing for the entire decompressed original image data stored in the memory (step S1904-2).

When mirror image processing is performed only for the image data in the decompressed original image data that is not located in an area corresponding to the encoded image data, combined image data of the image data that has been subjected to mirror image processing and the encoded image data is stored as the processed image data in the memory.

In step S1905, the CPU 301 transmits the image data stored in the memory to the decompression unit 316, causes the decompression unit 316 to perform raster expansion, and transmits image data that has been subjected to raster expansion to the printer image processing unit 315.

In step S1906, the printer image processing unit 315 performs image data editing corresponding to attribute data added to the original image data transmitted from the decompression unit 316. The processing contents are equal to the processing contents described with reference to FIG. 6. Then, in this processing, the encoded image data transmitted in step S1804 is combined with the original image data. That is, the encoded image combining portion 607 of the printer image processing unit 315 combines the encoded image data transmitted in step S1804 with the original image data in accordance with information position coordinates.

More specifically, the encoded image combining portion 607 combines the original image data output from the output gamma correction portion 605 with the encoded image data transmitted in step S1804.

Then, the halftone correction portion 606 performs halftone processing for the combined image data in accordance with the number of grayscale levels of the printer device 14. The combined image data that has been subjected to halftone processing is transmitted via the printer I/F 314 to the printer device 14.

In step S1907, the printer device 14 forms an image of the combined image data on output paper.

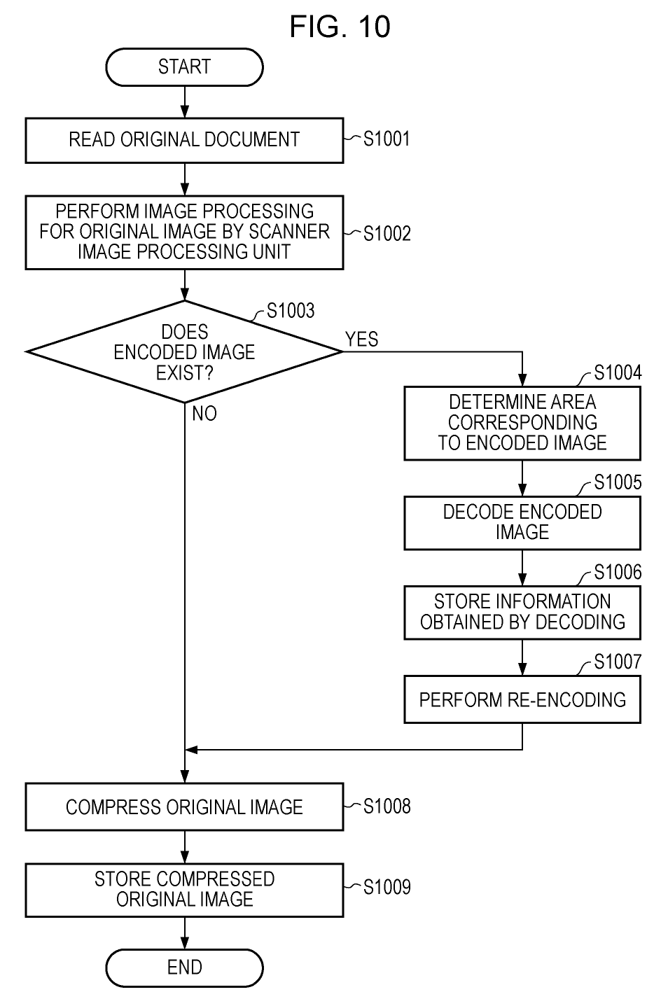

FIG. 10 is a flowchart showing a series of processing for reading an original document and storing the original document as image data. When an original document to be read includes a plurality of pages, the process described below is performed for each of the plurality of pages.

In step S1001, the CPU 301 transmits an original document read by the scanner device 13 as image data to the scanner image processing unit 312 via the scanner I/F 311.

In step S1002, the scanner image processing unit 312 performs the processing described with reference to FIG. 5 for the image data transmitted in step S1001 to generate new image data and attribute data. The scanner image processing unit 312 also performs processing for adding the attribute to the new image data.

In step S1003, the decoding portion 507 of the scanner image processing unit 312 determines whether or not encoded image data exists in the new image data generated in step S1002. When the decoding portion 507 detects encoded image data in step S1003, the process proceeds to step S1004. When the decoding portion 507 does not detect encoded image data in step S1003, the process proceeds to step S1008.

In step S1004, the decoding portion 507 determines an area of the original image corresponding to the detected encoded image data, and transmits information on the area to the RAM 302. The area information is stored in the RAM 302.

In step S1005, the decoding portion 507 decodes the encoded image data to acquire information. Since image editing, such as negative/positive inversion or mirror image processing, has not been performed at this stage, the encoded image data has not been damaged. Thus, the original data can be extracted from the encoded image data, as shown in FIG. 15.

In step S1006, the CPU 301 transmits, using a data bus (not shown), the information obtained by decoding in step S1005 to the RAM 302, and the information is stored in the RAM 302.

In step S1007, the CPU 301 re-encodes the decoded information to generate encoded image data, and transmits the re-encoded image data to the encoded image combining portion 607 of the printer image processing unit 315. Combining processing performed by the encoded image combining portion 607 will be described later as the processing of step S1206. The re-encoding processing is achieved when the CPU 301 executes a program stored in the RAM 302, and encoded image data is generated.

In step S1008, the compression unit 313 divides the new image data generated by the scanner image processing unit 312 into a plurality of blocks each including 32×32 pixels to generate a plurality of pieces of tile image data. The compression unit 313 also compresses the image data including the plurality of pieces of tile image data.

In step S1009, the CPU 301 transmits the image data compressed by the compression unit 313 to the RAM 302, and the compressed image data is stored in the RAM 302.

The CPU 301 transmits the image data to the image conversion unit 317 according to need. After image processing is performed for the image data, the image data that has been subjected to image processing is transmitted to the RAM 302. Then, the processed image data is stored in the RAM 302.

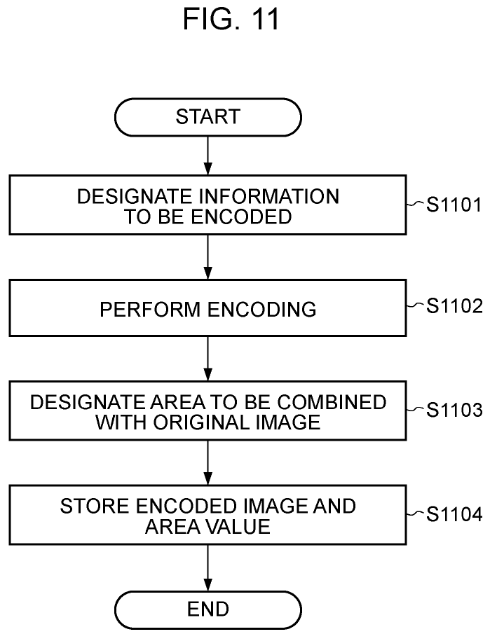

FIG. 11 is a flowchart illustrating a process performed when the encoded image printing button 806 shown in FIG. 8 is pressed. The encoded image printing button 806 is used for adding new encoded image data to read and stored original image data, which has been described with reference to the flowchart shown in FIG. 10. The encoded image printing button 806 is displayed on the operation device 12 of the image forming apparatus 10, as described above. Thus, when the encoded image printing button 806 is pressed, the depression of the encoded image printing button 806 is reported to the controller device 11 via the operation device I/F 305. The process described below is performed under the control of the CPU 301.

When an original document to be read includes a plurality of pages, the process described below is performed for each of the plurality of pages, as in FIG. 10.

In step S1101, the CPU 301 stores information to be converted into encoded image data, which is designated by the user using an encoding information designation unit (not shown), in the RAM 302. The information to be converted into encoded image data is not particularly limited. For example, information to be converted into encoded image data may be a document file stored in the PC 40 or the HDD 304 of the image forming apparatus 10 or a character string input using a virtual keyboard (not shown).

In step S1102, the CPU 301 executes a program stored in the RAM 302 to generate encoded image data from the information stored in step S1101.

In step S1103, the CPU 301 designates a combining area to be combined with the original image in accordance with the position coordinates in the original designated by the user using the encoding information designation unit (not shown) and the size of the generated encoded image data. Referring to FIG. 9, the combining area corresponds to the area occupied by the encoded image data 902 when the origin (0,0) is set at the upper left corner of the original image 901 stored in the RAM 302, the main-scanning direction is defined as X axis, and the sub-scanning direction is defined as Y axis. In the example shown in FIG. 9, the area corresponding to the encoded image data 902, that is, the combining area, corresponds to a rectangular area defined by (X0,Y0), (X1,Y0), (X0,Y1), and (X1,Y1).

In step S1104, the CPU 301 transmits the encoded image data generated in step S1102 and the position coordinates explained in step S1103 to the encoded image combining portion 607 of the printer image processing unit 315 via a data bus (not shown). Combining processing performed by the encoded image combining portion 607 will be described later as the processing of step S1206.

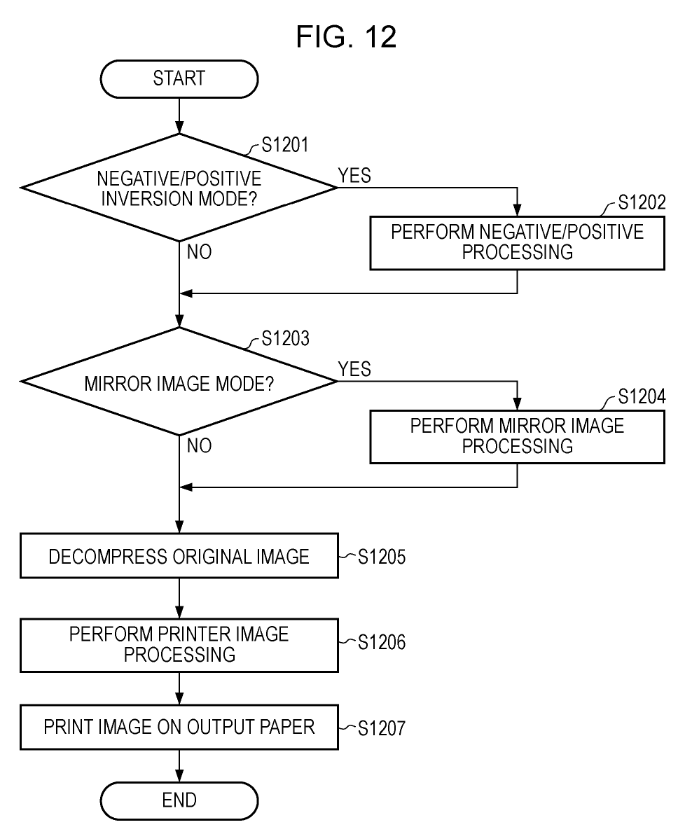

FIG. 12 is a flowchart showing a process performed when image data obtained by combining encoded image data generated by the processes described with reference to the flowcharts shown in FIGS. 10 and 11 is output to output paper. That is, in the output process described below, outputting is performed through the printer I/F 314 to the printer device 14. Thus, the output process described below is performed under the control of the CPU 301.

When image data to be output includes a plurality of pages, the process described below is performed for each of the plurality of pages, as in FIGS. 10 and 11.

In step S1201, the CPU 301 determines whether or not negative/positive inversion is designated on the application mode setting screen 800 shown in FIG. 8, that is, determines whether or not the negative/positive setting button 804 is pressed. When the CPU 301 determines in step S1201 that negative/positive inversion has been designated, the process proceeds to step S1202. When the CPU 301 determines in step S1201 that negative/positive inversion has not been designated, the process proceeds to step S1203.

In step S1202, the CPU 301 performs negative/positive inversion to invert the luminance of an image, for the original image. That is, RGB data of each of a plurality of pixels in the original image is inverted. For example, when a pixel value is between 0 and 255, values obtained by subtracting RGB values of a pixel from 255, which is the maximum pixel value, are used as respective RGB values of the pixel after inversion.

As described above, in step S1202, negative/positive inversion can be performed for the entire original image. However, negative/positive inversion may be performed as described below.

That is, when area information (information on an area of the original image corresponding to encoded image data) is stored in the RAM 302 in step S1004, the CPU 301 reads the area information. Then, the CPU 301 performs negative/positive inversion for an area of the original image not corresponding to the area indicated by the read area information. In this case, since encoded image data is originally embedded in the original image data and the encoded image data exists in the area indicated by the area information, processing for combining the encoded image data is not performed in step S1206, which will be described later.

In step S1203, the CPU 301 determines whether or not mirror image outputting is designated on the application mode setting screen 800 shown in FIG. 8, that is, determines whether or not the mirror image setting button 805 is pressed. When the CPU 301 determines in step S1203 that mirror image outputting has been designated, the process proceeds to step S1204. When the CPU 301 determines in step S1203 that mirror image outputting has not been designated, the process proceeds to step S1205.

In step S1204, the CPU 301 performs mirror image processing for the original image. Although mirror image processing can be performed for the entire original image in step S1204, mirror image processing may be performed as described below.

When area information is stored in the RAM 302 in step S1004, the CPU 301 reads the area information, as in step S1202. Then, the CPU 301 performs mirror image processing for an area of the original image not corresponding to the area indicated by the read area information. In this case, since encoded image data is originally embedded in the original image data and the encoded image data exists in the area indicated by the area information, processing for combining the encoded image data is not performed in step S1206, which will be described later.

In step S1205, the CPU 301 transmits the image data stored in the RAM 302 to the decompression unit 316. The decompression unit 316 decompresses the image data. The decompression unit 316 also performs raster expansion for the decompressed image data including a plurality of pieces of tile image data, and transmits image data that has been subjected to raster expansion to the printer image processing unit 315.

In step S1206, the printer image processing unit 315 performs image data editing corresponding to attribute data added to the image data transmitted from the decompression unit 316. The processing contents are equal to the processing contents described with reference to FIG. 6. In this processing, the encoded image data generated in step S1007 or step S1102 is combined with the original image data. That is, the encoded image combining portion 607 of the printer image processing unit 315 combines the transmitted encoded image data with the original image data in accordance with the position coordinates. The CPU 301 stores the combined image data in the RAM 302.

More specifically, the encoded image combining portion 607 combines the original image data output from the output gamma correction portion 605 with the encoded image data generated in step S1007 or step S1102.

Then, the halftone correction portion 606 performs halftone processing for the combined image data in accordance with the number of grayscale levels of the printer device 14. The combined image data that has been subjected to halftone processing is transmitted via the printer I/F 314 to the printer device 14.

As described with reference to steps S1202 and S1204, when encoded image data is originally embedded in the original image data and negative/positive inversion or mirror image processing is performed for only an area of the original image data not corresponding to the encoded image data, the combining processing is not performed in step S1206. In step S1207, the printer device 14 forms an image of the combined image data on output paper.

Another exemplary embodiment will be described next. The description will mainly focus on differences from the previously described exemplary embodiments, mainly the exemplary embodiment just described. In the description below, for the convenience of description, negative/positive inversion will be explained. However, obviously, the description below is also applicable to other types of image editing, such as mirror image processing.

When negative/positive inversion described with reference to FIG. 12 is performed, warning information may be transmitted to the user via the operation device 12 before negative/positive inversion for an area not corresponding to the area indicated by area information is automatically performed. That is, as in the first embodiment, the user may be able to give an instruction to perform negative/positive inversion for an area not corresponding to the area indicated by the area information by automatic determination from the area information. Alternatively, the user who has received the warning information may be able to reset the area information using the operation device 12. Alternatively, the user may be able to cancel negative/positive inversion.

Although the warning information may be displayed on the operation device 12, the warning information may be displayed on the PC 40 via a network, such as the LAN 50.

The present invention is applicable to a system including a plurality of apparatuses (for example, a computer, an interface apparatus, a reader, a printer, and the like) or to an apparatus including a single device (for example, an image forming apparatus, a printer, a facsimile machine, or the like).

An aspect of the present invention may also be attained by reading a program for implementing the processes shown by the flowcharts described in the foregoing embodiments from a storage medium storing the program and executing the program by a computer (or a CPU or a microprocessing unit (MPU)) of the system or the apparatus. In this case, the program read from the storage medium attains the functions of the foregoing embodiments.

The storage medium for supplying the program may be, for example, a flexible disc, a hard disc, an optical disc, a magneto-optical disc, a CD-ROM, a compact disc-recordable (CD-R), a magnetic tape, a nonvolatile memory card, a ROM, or the like.

The functions of the foregoing embodiments can be attained by executing the read program by the computer. In addition, the functions of the foregoing embodiments can also be attained by performing part or all of the actual processing by an operating system (OS) or the like running on the computer on the basis of instructions of the program.

In addition, the program read from the storage medium may be written to a memory provided in a function expansion board of the computer or a function expansion unit connected to the computer. The functions of the foregoing embodiments can also be attained by performing part or all of the actual processing by the CPU or the like arranged in the function expansion board or the function expansion unit on the basis of instructions of the program.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Application No. 2006-309316 filed Nov. 15, 2006, which is hereby incorporated by reference herein in its entirety.

What is claimed is:

1. An image processing apparatus performing image editing for original image data, comprising:
a determining unit configured to determine whether encoded image data exists in the original image data; and
a processing unit configured to
when the determining unit determines that encoded image data does not exist in the original image data, perform the image editing for the original image data, and
when the determining unit determines that encoded image data exists in the original image data, read information from the encoded image data, re-encode the read information to generate re-encoded image data, perform the image editing for image data in the original image data that is not located in an area corresponding to the encoded image data, and combine the image data that has been subjected to the image editing with the generated re-encoded image data.

2. The image processing apparatus according to claim 1, wherein the image editing is negative/positive inversion in which the luminance of an image is inverted or mirror image processing in which vertical or horizontal inversion is performed as if the image is reflected in a mirror.

3. An image processing apparatus capable of performing image editing and capable of outputting an image including an encoded image, comprising:
a determining unit configured to determine whether setting for the image editing has been performed; and
an image editing unit configured to, when the determining unit determines that setting for the image editing has been performed, perform the image editing for data in image data of the image not corresponding to encoded image data of the encoded image,
wherein when encoded image data of the encoded image does not originally exist in the image data of the image, the data that has been subjected to the image editing is combined with the encoded image data in accordance with position information of the encoded image data in the image data.

4. The image processing apparatus according to claim 3, further comprising:
an informing unit configured to, before the image editing is performed, output warning information indicating that encoded image data exists in the image data; and
a selecting unit configured to select subsequent processing to be performed in accordance with the warning information,
wherein image forming processing does not start before the subsequent processing to be performed is selected.

5. The image processing apparatus according to claim 4, wherein the image editing is negative/positive inversion in which the luminance of the image is inverted or mirror image processing in which vertical or horizontal inversion is performed as if the image is reflected in a mirror.

6. The image processing apparatus according to claim 3, wherein the image editing is negative/positive inversion in which the luminance of the image is inverted or mirror image processing in which vertical or horizontal inversion is performed as if the image is reflected in a mirror.

7. An image forming apparatus capable of performing image editing and capable of outputting an image including an encoded image, comprising:
a determining unit configured to determine whether setting for the image editing has been performed;
an image editing unit configured to, when the determining unit determines that setting for the image editing has been performed, perform the image editing for image data of the image; and
a combining unit configured to combine the data that has been subjected to the image editing with the encoded image data in accordance with position information of the encoded image data in the image data.

8. The image forming apparatus according to claim 7, further comprising:
an informing unit configured to, before the image editing is performed, output warning information indicating that encoded image data exists in the image data; and
a selecting unit configured to select subsequent processing to be performed in accordance with the warning information,
wherein image forming processing does not start before the subsequent processing to be performed is selected.

9. The image forming apparatus according to claim 7, wherein the image editing is negative/positive inversion in which the luminance of the image is inverted or mirror image processing in which vertical or horizontal inversion is performed as if the image is reflected in a mirror.

10. An image processing method for performing image editing for original image data, comprising:
determining whether encoded image data exists in the original image data;
when it is determined that encoded image data does not exist in the original image data, performing the image editing for the original image data; and
when it is determined that encoded image data exists in the original image data, reading information from the encoded image data, re-encoding the read information to generate re-encoded image data, performing the image editing for image data in the original image data that is not located in an area corresponding to the encoded image data, and combining the image data that has been subjected to the image editing with the generated re-encoded image data.

11. An image processing method for use in an image processing apparatus capable of performing image editing and capable of outputting an image including an encoded image, comprising:
determining whether setting for the image editing has been performed; and
when it is determined that setting for the image editing has been performed, performing the image editing for data in image data of the image not corresponding to encoded image data of the encoded image,
wherein when encoded image data of the encoded image does not originally exist in the image data of the image, the data that has been subjected to the image editing is combined with the encoded image data in accordance with position information of the encoded image data in the image data.

12. The image processing method according to claim 11, further comprising:
before the image editing is performed, outputting warning information indicating that encoded image data exists in the image data; and
selecting subsequent processing to be performed in accordance with the warning information,
wherein image forming processing does not start before the subsequent processing to be performed is selected.

13. The image processing method according to claim 12, wherein the image editing is negative/positive inversion in which the luminance of the image is inverted or mirror image processing in which vertical or horizontal inversion is performed as if the image is reflected in a mirror.

14. An image processing apparatus comprising:
a first determining unit configured to determine whether encoded image data exists in original image data;
a second determining unit configured to determine whether to perform mirror image processing for the original image data; and
an informing unit configured to, when the first determining unit determines that encoded image data exists in the original image data and the second determining unit determines that mirror image processing is to be performed for the original image data, output warning information.

15. An image processing apparatus comprising:
a first determining unit configured to determine whether encoded image data exists in original image data;
a second determining unit configured to determine whether to perform mirror image processing for the original image data; and
a control unit configured to, when the first determining unit determines that encoded image data exists in the original image data and the second determining unit determines that mirror image processing is to be performed for the original image data, perform control such that mirror image processing is performed for at least image data other than the encoded image data in the original image data and the image data that has been subjected to mirror image processing and the encoded image data that has not been subjected to mirror image processing are formed on a sheet.

16. The image processing apparatus according to claim 15, wherein although mirror image processing is not performed for the encoded image data to be formed on the sheet together with the image data that has been subjected to mirror image processing by the control unit, the encoded image data is moved to a position corresponding to a mirror image.
